(19) United States
(12) Patent Application Publication
(10) Pub. No.: US 2008/0288969 A1
(43) Pub. Date: Nov. 20, 2008

(54) Unattended Data Storage System

(76) Inventor: Victor Waiman, Herzelia (IL)

Correspondence Address: Fleit Gibbons Gutman Bongini & Bianco PL, 21355 EAST DIXIE HIGHWAY, SUITE 115, MIAMI, FL, 33180, US

(21) Appl. No.: 10/599,269

(22) PCT Filed: Mar. 31, 2005
(86) PCT No.: PCT/IL2005/000359

§ 371 Date: Sep. 25, 2006

Related U.S. Application Data
(60) Provisional application No. 60/558,128, filed on Apr. 1, 2004.

(51) Int. Cl. G11B 17/03

(52) U.S. Cl. 720/615

(57) ABSTRACT

The present invention discloses a mechanical apparatus for performing automatic and unattended data storage and retrieval tasks. The apparatus enables automating the data storage procedure of recording files on multiple compact discs (CDs) or digital versatile discs (DVDs) without relaying on the intervention of a human operator. The apparatus automatically transfers empty discs into the disc drive, removes them from the disc drive and marks them appropriately once the disc writing and reading procedures are completed. The apparatus is composed of an arm equipped with a gripping mechanism such as suction cups or mechanical grippers which can move vertically and horizontally and transfer the discs according to necessity. Two embodiments are described: in the first embodiment the horizontal movement of the arm is circular and is performed around a central axis; in the second the movement is along a straight line and the arm is positioned on a rack.

### BACKGROUND OF THE INVENTION

The present invention relates to the field of automatic systems for recording data over optical media and more specifically to mechanical systems for controlling the procedure of recording data over multiple optical media units.

The use of optical media, such as compact disc (CD) and digital versatile disc (DVD), is ever expanding. Optical media drives have become an integral part of any standard personal and professional computer. The high reliability and the ease of use have made reading and writing data onto the CD and DVD a common method for transferring and storing data. But the CDs and DVDs have limited storage capacity and the ever growing needs for disc space demands that on many occasions, users wanting to transfer, backup or archive data need to use multiple discs. In such cases the user needs to manually replace the discs according to the needs of the reading or writing application and to individually mark each disc for identification, a restriction that turns potentially automatic tasks into labor consuming tasks. Furthermore, data on discs has to be organized to allow prompt file location for data restoring. There is therefore a need for an apparatus that can automatically change the discs in the CD or DVD drive of the computer, print the identification information, store the data in a manner that can be easily found in the discs and would relieve the need for a manual execution of such operations.

U.S. Pat. No. 5,053,948 discloses an optical archive storage system which includes a large number of off-line optical discs. The discs are selectively transported to read/write units by a robotic manipulator. Access to the data files on the discs is maintained and controlled through the use of a token file on a magnetic storage device on a controller computer for each data file on each disc. The file attributes which the operating system of the computer assigns to the token file are used to control access and ownership of the data files on the discs.

While this system automatically operates the procedure of storing data on a large number of discs, it is designed to operate as a fully automated “black box” system which does not enable using the discs manually. It is therefore not suited for operating tasks such as making multiple duplications of the same content on a large number of discs which could be later used individually in a manual fashion.

Other patents, such as U.S. Pat. No. 5,546,315 titled “Simplified Storage Media Library Subsystem” and international patent application no. WO0196884 titled “Self Teaching Robotic Carrier Handling System” offer similar solutions for fully automatic large-scale storing facilities which use robotic mechanisms to allow making use of different types of storing units. There is therefore a need for a system and a method which would allow automating the use of multiple storage units, such as CDs and DVDs, which can operate in a fully automated and a semi-automated modes according to the users' needs.

### SUMMARY

The present invention discloses an automatic data storage system enabling changing of a media storage component within a writing-reading device during a data storage process, said system comprising a programmable automatic handler. The handler includes at least one picking arm and at least one placing arm, wherein the media storage component is replaced according to a predefined scheduling scheme. The picking arm of the disclosed data storage system may move along a rack or around a single axis.

The data storage system also includes a printing device for writing on each media storage component during the storage process and a software module for formatting the media storage components and generating a catalog of the stored information. The catalog may include the following details: the list of files stored in any individual storage media component, date of the file generation, size of the stored file, list of all printed information on the discs, contents of all the discs previously recorded or estimated location of the storage sessions to follow until the complete session finishes.

The printing device prints on each individual recorded disc by an integrated thermal transfer printer. The printed information on each disc includes at least one of the following: date, serial number and customer defined information, enabling visual identification of the recorded disc as an independent element in the data storage process.

The data storage system includes an in tray and an out tray; the picking arm transfers the media storage component from the in tray to the writing-reading device and from there to the out tray. The handler device includes vacuum suction cups or mechanical gripper for gripping the media storage component.

The data storage system also includes a visual recognizer device. Using this device the handler may be programmed to search for a specific media storage component from the collection of media storage components. The specific media storage component is identified according to the data printed on it. The search is processed by transferring the media storage component one by one from one stock holder tray to the other and reading the label of each media storage component until the desired media storage component is found.

### BRIEF DESCRIPTION OF THE DRAWINGS

These and further features and advantages of the invention will become more clearly understood in light of the ensuing description of a preferred embodiment thereof, given by way of example only, with reference to the accompanying drawings, wherein—

FIG. 1 is an illustration of a general overview of the first embodiment of the present invention;

FIG. 2 illustrates different components of the first embodiment of the present invention;

FIG. 3 is a sectional illustration of the first embodiment viewed from above;

FIG. 4 is a full front sectional illustration of the first embodiment;

FIG. 5 is a side section illustration of the first embodiment of the present invention;

FIG. 6 is a three-dimensional illustration of the first embodiment of the present invention;

FIG. 7 is a three-dimensional illustration of the second embodiment of the present invention as it is viewed from the front;

FIG. 8 is a three-dimensional illustration of the second embodiment as it is viewed from behind;

FIG. 9 is a front section illustration of the second embodiment of the present invention;

FIG. 10 is a side section illustration of the second embodiment of the present invention;

FIG. 11 is a section illustration of the second embodiment as it is seen from the top;

FIG. 12 is a flowchart of the operation of the preferred embodiments of the present invention;

FIG. 13 is a block diagram of the electronic circuit that control the system.

### DESCRIPTION OF THE PREFERRED EMBODIMENTS

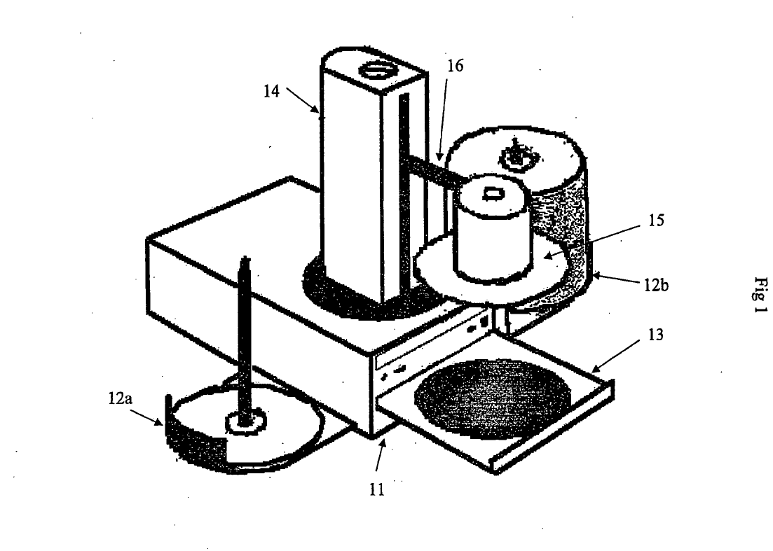

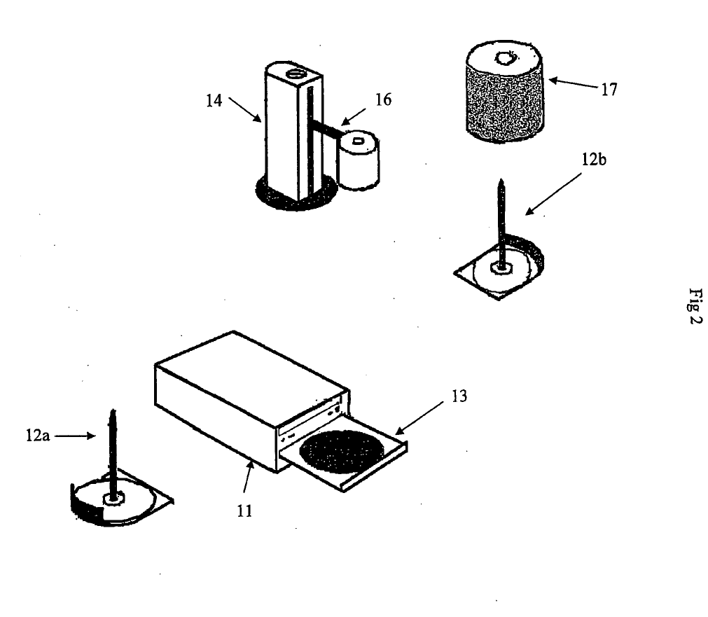

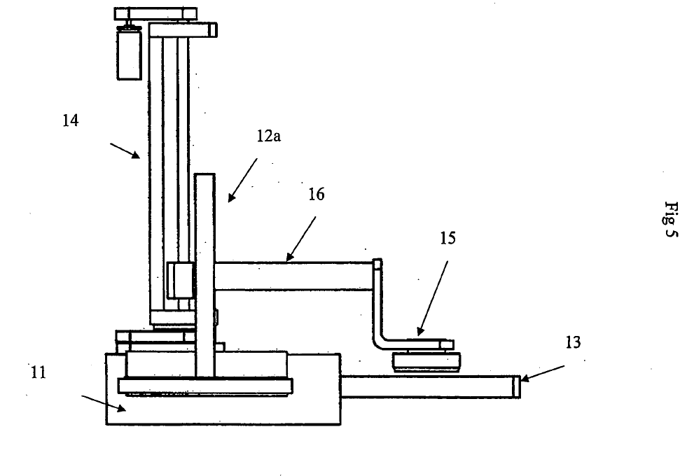

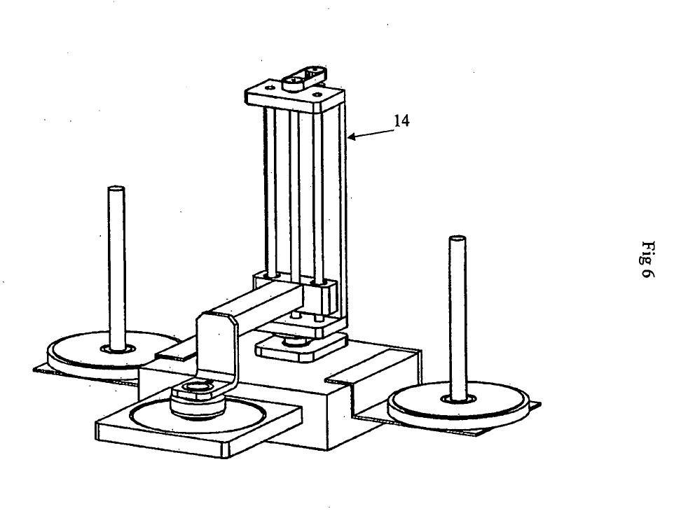

In light of the shortcoming of the present day technology as described above, the present invention is a new, simple and low cost solution for performing automatic and unattended data storage and retrieval tasks. The present invention is an apparatus and method which automates the data storage procedure of recording files on multiple compact discs (CDs) or on digital versatile discs (DVDs) without relaying on the intervention of a human operator. The preferred embodiments of the present invention are simple mechanic apparatuses which operate the transference of an empty disc into the disc drive, remove it from the disc drive and mark it appropriately once the disc writing and reading procedures are completed. Disclosed are two embodiments of the present invention which perform the same functions but differ in their proposed mechanisms. FIGS. 1-6 are illustrations of the first embodiment in accordance to the present invention. As illustrated in FIG. 1, the apparatus 10, whose mode of operation is described below, is positioned on top of a CD or DVD drive 11. The different components that compose apparatus 10 are illustrated in greater detail in FIG. 2. The two disc stocking units 12a, 12b positioned on either side of the apparatus may hold stocks of discs. On top of the disc drive 11 there is a tower 14. The arm 16 is connected to the tower 14 on one end and at the other end it has a disc handling device 15 comprised of vacuum suction cups or mechanical grippers, a printer and a print visual recognizer. This device enables the apparatus 10 to get a grip on a disc using a gripping mechanism such as the vacuum suction cups or the mechanical grippers. The disc drive 11 and the discs are standard home and office equipments and are not within the scope of the invention. Additionally, it is to be understood that the automatic and unattended data storage and retrieval system of the present invention can be utilized for any type of optical disc drive such as an audio CD, a CD-ROM, or a video CD or DVD.

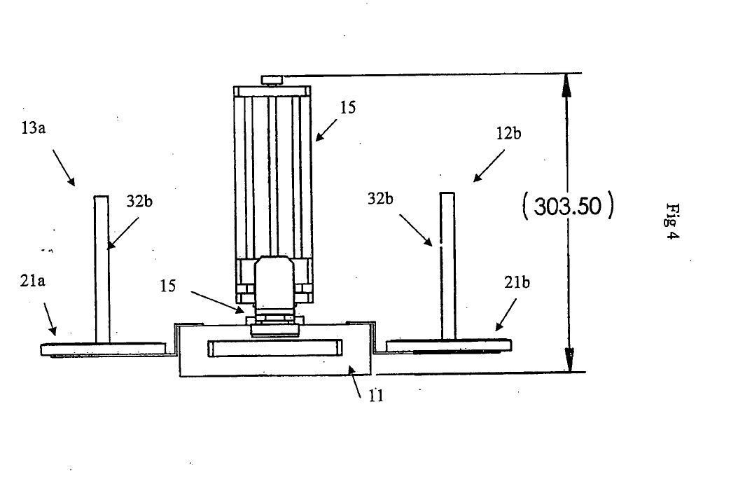

Following is a description of the apparatus's method of operation which may be better understood with reference to drawings 3-6 of the apparatus. Before operating the apparatus 10 a stock of empty discs is placed by the operator at the disc stock holder 12 on one side of the apparatus (in this example the empty discs are placed on the right side of the apparatus in disc stock holder 12b). As the apparatus receives a command to operate, the tower 14, which rotates on its axis R182 and makes a full circle 30, turns counter-clockwise in the direction of disc stock holder 12b. As the arm 16 reaches the center of the disc stock holder 12b and is positioned above the holder's rod 32b it stops. The arm, which may move up and down, is lowered until it reaches the top disc of stock in stock holder 12b. Activating the gripping mechanism allows the arm 16 to get a grip on the top disc and pick it up from the stock. Once the gripping mechanism has a grip on the disc the arm 16 is pulled back up. The tower 14 then turns clockwise until the arm 16 is aligned with disc drive tray 13. The arm 16 is lowered until the disc is situated in its proper place inside the disc drive tray 13, as illustrated in FIGS. 4, 5 and 6. The gripping mechanism is then deactivated and the arm 16 is pulled back up leaving the disc in the disc drive tray 13. The disc drive 11 may then be commanded to close its tray 13 and is ready to operate.

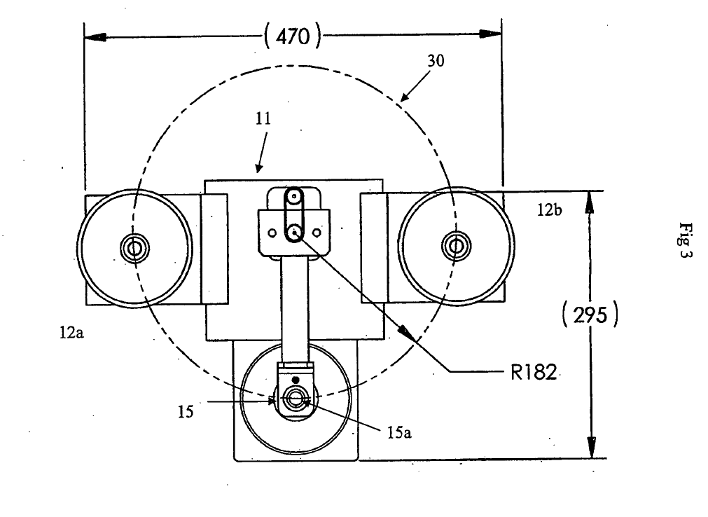

Once the operation on the disc is completed the disc drive 11 is commanded to open its tray 13 and the apparatus 10 may then remove the disc. The arm 16 is lowered to pick up the disc from the disc drive tray 13 using the gripping mechanism. It is then pulled up, the tower rotates until the arm is aligned with the left disc stock holder 12a and is lowered until the disc is put in place. As is evident in FIG. 3a, device 15 includes a circular opening that matches the radius of the disc stock holder rod 32 and allows it to reach discs on the bottom of the disc stock holders 12 without colliding with its rod 32. The printer on the disc handling device 15 may be then used to print identification information on the disc including date, disc number and user defined text. Then the gripping mechanism is turned off and the arm is pulled back up. In order to continue the process the tower 14 turns again to the left disc stock holder 12a to pick up the next disc.

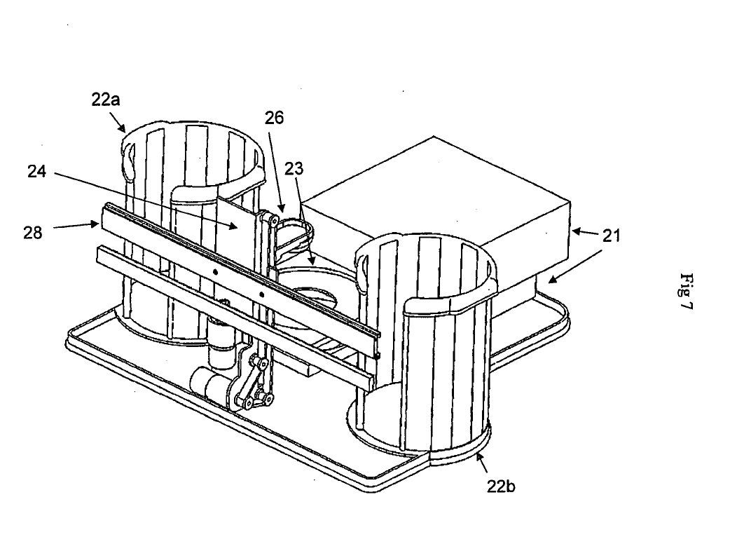

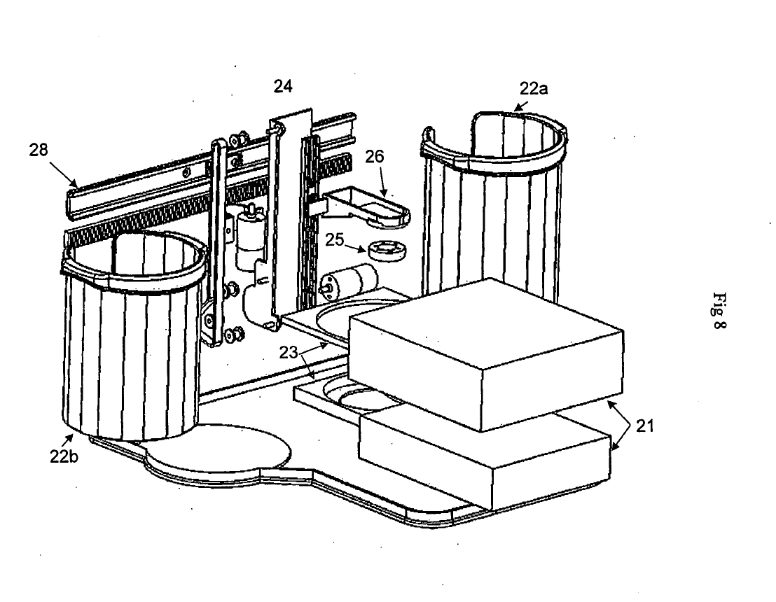

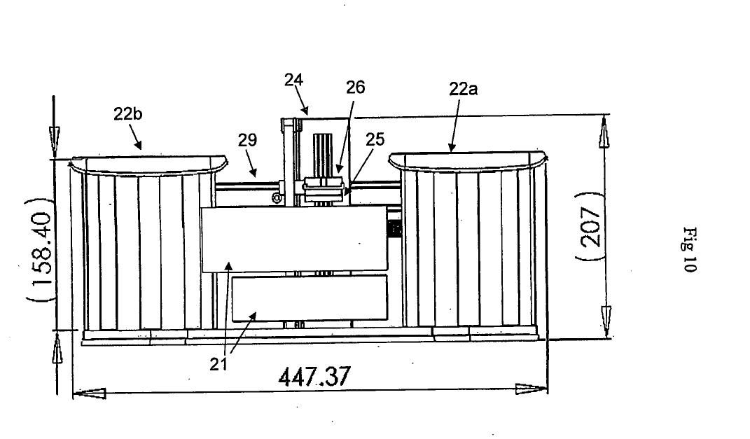

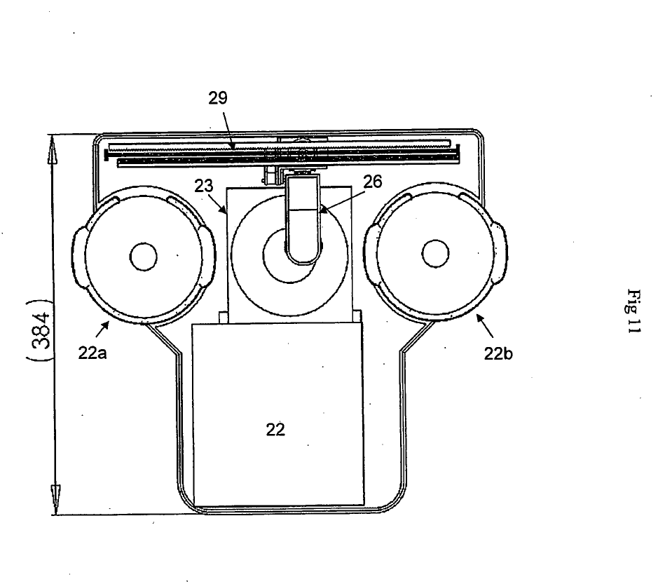

The second embodiment of the present invention, which is illustrated in FIGS. 7-10, operates according to similar principles, but instead of operating in a circular motion, it moves the disc units along a straight line. As depicted in FIG. 7, disc holder 22a, 22b are positioned on the two sides of the disc drive 21 and printer 41. In this embodiment the printing is performed inside printer 41 by which is a thermal transfer printer. As it is clearly shown in FIG. 11 which is a view of the device from above, discs are moved along line 29 between the four positions (the two disc holder 22a, 22b and the disc drive tray 23 and the printer tray 43).

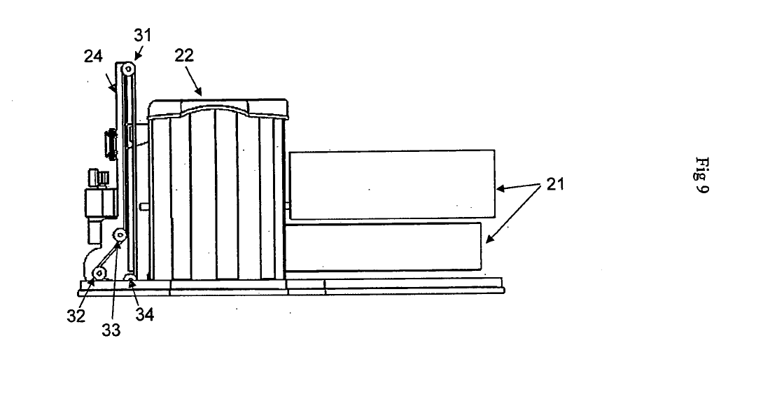

Similarly to the first embodiment, the discs are picked up by arm 26 using a gripping mechanism such as suction cups or mechanical grippers 25 (FIG. 7). The arm 26 may move up and down along tower 24, and the tower may move along line 29 to locate the arm in the necessary position. The horizontal-movement of the tower 24 is enabled by rack 28 whose linear movement is controlled by a motor. The vertical movement of the arm 26 is performed on four tower rods 31, 32, 33 and 34 (FIG. 9). This movement is controlled by a second motor.

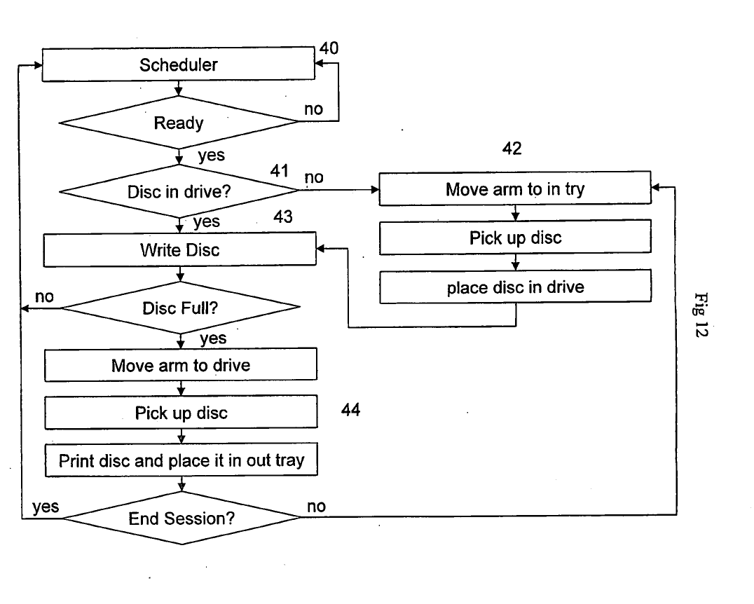

FIG. 12 is a flowchart of the manner of operation of the system's preferred embodiments. The process is initiated by the scheduler, which monitors the operation of the device and ensures that each operation is complete before commencing with the next one. As the scheduler approved the operation the system checks whether there is a disc inside the designated drive 41. Provided that the disc drive is empty, the device first brings a new disc from the in tray to the disc tray 42 in order to enable the writing operation to proceed. If reaches its full capacity before completing the writing task, the disc is removed from the drive, positioned in the printer tray where identifying information is printed on it and then it is put in the out tray. Next, a new disc is moved from the in tray to the drive, in order to allow the writing procedure to proceed.

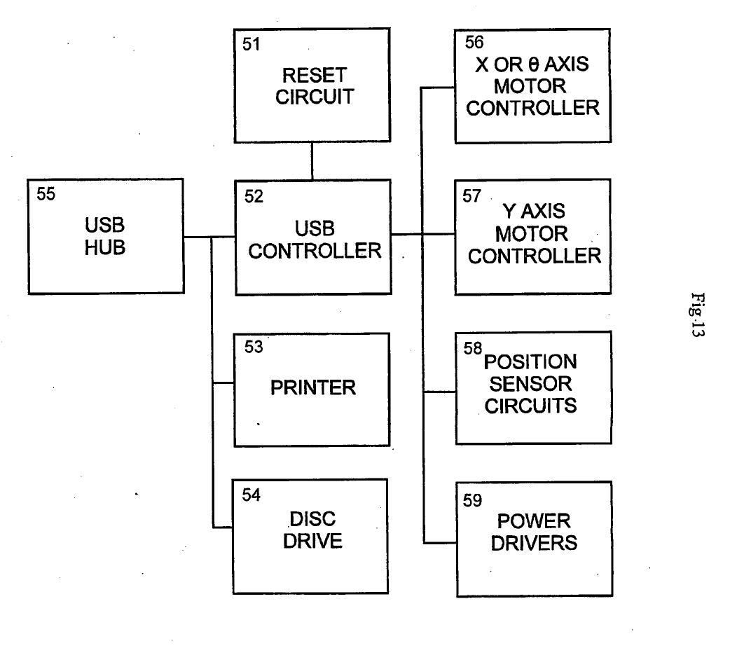

FIG. 13 is a block diagram of the electronic circuit which controls the system. A reset circuitry 51, based on Schottky and passive components, is used to ensure proper power-up activation of the system. The USB microcontroller 52 connects the system to a host computer through a universal serial bus (USB) and enables the logic signals to activate the robot under software control. A USB hub 55 is used to select USB signal sources as provided by a host computer, by the USB microcontroller 52, the printer 53 or by the disc drive 54. The two motors which are used in the system to rotate (θ axis) or to move horizontally (X axis) the robot tower and move the robot arm up and down (Y axis) are driven by motor controllers 56 and 57 accordingly. The air compressor which generates the vacuum in the vacuum suction cups or activates a mechanical gripper is activated by a power driver 59. Proximity switches are installed in the robot assembly to detect the position of the robot arm in relation to the tower and the direction it is facing. These proximity switches are driven by sensor circuits 58 connected to the microcontroller 52.

The invention may also include a cataloging algorithm which can write on each disc the relevant information according to the recorded data on the disc using readable ASCII characters which may be read using a compatible disc drive or any available text viewer program. Such information may include size, generation date and the path of the original location of the stored data, as well as the sequential number of the current disc in the estimated total number of discs used in the procedure, specific preprogrammed information and any other information that may be needed for identifying the specific disc and its content. The catalog includes the information of the files written in the current disc as well as the information of the files written in the previous writing sessions, thus allowing to locate a specific file in any disc that contains it. Similarly the device may be programmed to search for a specific disc from the stock 17, according to the data printed on it. In this case the apparatus flips through the disc stock by transferring the discs one by one from one disc stock holder to the other, reading the label of each disc as it reaches it, until the desired disc is found.

Following is an example of the catalog format of the recorded data used by the software of this invention:

SESSION NUMBER: XXX
CURRENT DISC NUMBER: ###
SESSION STARTING DATE: DD-MM-YYYY
SESSION ENDING DATE: DD-MM-YYYY
STARTING DATE OF DISC NUMBER 001: DD-MMYYYY
ENDING DATE OF DISC NUMBER 001: DD-MM-YYYY
STARTING DATE OF DISC NUMBER 002: DD-MM-YYYY
ENDING DATE OF DISC NUMBER 002: DD-MM-YYYY
. . .
STARTING DATE OF DISC NUMBER [### - 1]: DD-MM-YYYY
ENDING DATE OF DISC NUMBER [### - 1]: DD-MM-YYYY
LIST OF FILES, PATH, GENERATION DATE, SIZE IN DISC
NUMBER [001]
LIST OF FILES, PATH, GENERATION DATE, SIZE IN DISC
NUMBER [002]

While the above description contains many specifications, these should not be construed as limitations on the scope of the invention, but rather as exemplifications of the preferred embodiments. Those skilled in the art will envision other possible variations that are within its scope. Accordingly, the scope of the invention should be determined not by the embodiment illustrated, but by the appended claims and their legal equivalents.

What is claimed is:

1. An automatic data storage system enabling changing of a media storage component within a writing-reading device during a data storage process, said system comprising a programmable automatic handler, said handler including at least one picking arm, wherein the media storage component is replaced according to a predefined scheduling scheme.

2. The data storage system of claim 1 further comprising a printing device for writing on each media storage component throughout the storage process.

3. The data storage system of claim 1 further comprising a software module for formatting the media storage components and generating a catalog of the stored information.

4. The data storage system of claim 4 wherein the catalog includes at least one of the following items: the list of files stored in any individual storage media component, date of the file generation, size of the stored file, list of all printed information on the discs, contents of all the discs previously recorded or estimated location of the storage sessions to follow until the complete session finishes.

5. The data storage system of claim 3 wherein the printing device prints on each individual recorded disc by an integrated thermal transfer printer.

6. The data storage system of claim 3 wherein printed information on each disc includes at least one of the following: date, serial number and customer defined information, enabling identification of the recorded disc as an independent element in the data storage process.

7. The data storage system of claim 1 further including at least one in tray and at least one out tray, wherein the picking arm transfers the media storage component from the in tray to the writing-reading device and from there to the out tray.

8. The data storage system of claim 1 wherein the handler device includes at least one vacuum suction cup for gripping the media storage component.

9. The data storage system of claim 1 wherein the handler device includes at least one mechanical gripper.

10. The data storage system of claim 1 further comprising a visual recognizer device wherein the handler is programmed to search for a specific media storage component from the collection of media storage components, according to identified data printed on said media storage component, said search is processed by transferring the media storage component one by one from one stock holder to another and reading the label of each media storage component until the desired media storage component is found.

11. The data storage system of claim 1 wherein the picking arm moves along a rack.

12. The data storage system of claim 1 wherein the picking arm moves around a single axis.
